(19) United States
(12) Patent Application Publication
(10) Pub. No.: US 2006/0233164 A1
(43) Pub. Date: Oct. 19, 2006

(54) Method to separate fibre channel switch core functions and fabric management in a storage area network

(75) Inventors: Surender V. Brahmaroutu, Round Rock, TX (US); Sadiq A. Shaik, Bangalore (IN)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/233,787

(22) Filed: Sep. 23, 2005

(30) Foreign Application Priority Data
Apr. 19, 2005 (IN) 970/DEL/2005

(51) Int. Cl. H04L 12/50; H04L 12/56

(52) U.S. Cl. 370/384; 370/410

(57) ABSTRACT

A method to separate fibre channel switch core functions and fabric management in a storage area network is disclosed. In accordance with one embodiment, a method of separating fibre channel switch core functions and management of a fabric in an information handling system includes separating data oriented functions and fabric oriented functions into distinct components. The method further including maintaining the data oriented functions in one or more switches. The method further including assigning the fabric oriented functions to a fabric manager, wherein the fabric manager comprises a separate component interconnected with the one or more switches.

### PRIORITY INFORMATION

This application claims foreign priority to Indian Patent Application Number 970/DEL/2005 filed Apr. 19, 2005.

### TECHNICAL FIELD

The present disclosure relates generally to information handling systems and, more particularly, to a method to separate fibre channel switch core functions and fabric management in a storage area network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One area of information handling system use that continues to see growth and development is that of storage area networks (SAN) including complex server storage and standalone server systems, server-to-storage systems, and standalone storage systems. Organizations around the globe are implementing SANs to solve a variety of technical and business requirements. As such, SANs are beginning to play a more vital role within the overall infrastructure of enterprises of all sizes.

In many instances, SAN installations include a plurality of servers coupled to a plurality of storage devices through a plurality of switches. In such installations, the complexity of the numerous connections between multiple servers and storage devices through numerous switches is often multiplied by the existence of similar numbers of secondary communication paths, creating redundancy and enhancing availability.

Switches are at the heart of this installation. Performance and speed of the system depends on the transfer of data through the switch. As the demand for data flow increases, the switches can also be the “bottlenecks” of the system.

To handle the demand, manufacturers are designing switches with more complexity and sophistication. Specifically, sophisticated switches are being designed to interconnect Fibre Channel (FC) based SANs. Although the sophistication and complexity increases functionality of the switch, the switch is priced higher and the deployment of the switch is more complex.

### SUMMARY

Therefore, a need has arisen for a method to optimize performance and availability of FC switches while minimizing design complexity.

In accordance with one embodiment of the present disclosure, a method of separating fibre channel switch core functions and management of a fabric in an information handling system includes separating data oriented functions and fabric oriented functions into distinct components. The method further including maintaining the data oriented functions in one or more switches. The method further including assigning the fabric oriented functions to a fabric manager, wherein the fabric manager comprises a separate component interconnected with the one or more switches.

In a further embodiment, a storage area network includes one or more storage units operable to store data. The storage area network further including a fibre channel switch communicatively coupled to the one or more storage units. The fibre channel switch able to perform data oriented functions. The storage area network further including a fabric manager, independent of the fibre channel switch and communicatively coupled to the fibre channel switch, able to perform fabric oriented functions.

In accordance with a further embodiment of the present disclosure, an apparatus for separating fibre channel switch core functions and management of a fabric in a storage area network includes a fabric manager communicatively coupled to a fibre channel switch, wherein the fabric manager is independent from the fibre channel switch. The fabric manager operable to perform fabric oriented functions.

One technical advantage of the present disclosure provides for a high availability of storage area network (SAN) fabric. Because the control and management of the SAN is performed in the fabric manager, resources within the fibre channel switch are freed up to perform additional data oriented functions. As such, the efficiency and performance of the fabric increases allowing for the high availability of the SAN fabric.

Another technical advantage of some embodiments of the present disclosure is scalability of the fabric. Because a topological database for the fabric configuration can be stored in the fabric manager, the addition of new switches to the fabric allows the fabric manager to configure and to initialize the switches without interfering with the rest of the fabric. As such, the SAN fabric will remain available during the introduction of newly added switches without disturbing any other switches. Thus, the fabric manager allows for scalability of the fabric without interfering with the currently active switches.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram showing an example embodiment of a storage area network including a fabric manager, according to teachings of the present disclosure; and

FIG. 2 is a flow chart for a method of separating fibre channel switch core functions and management of a fabric in an information handling system, according to teachings of the present disclosure.

### DETAILED DESCRIPTION

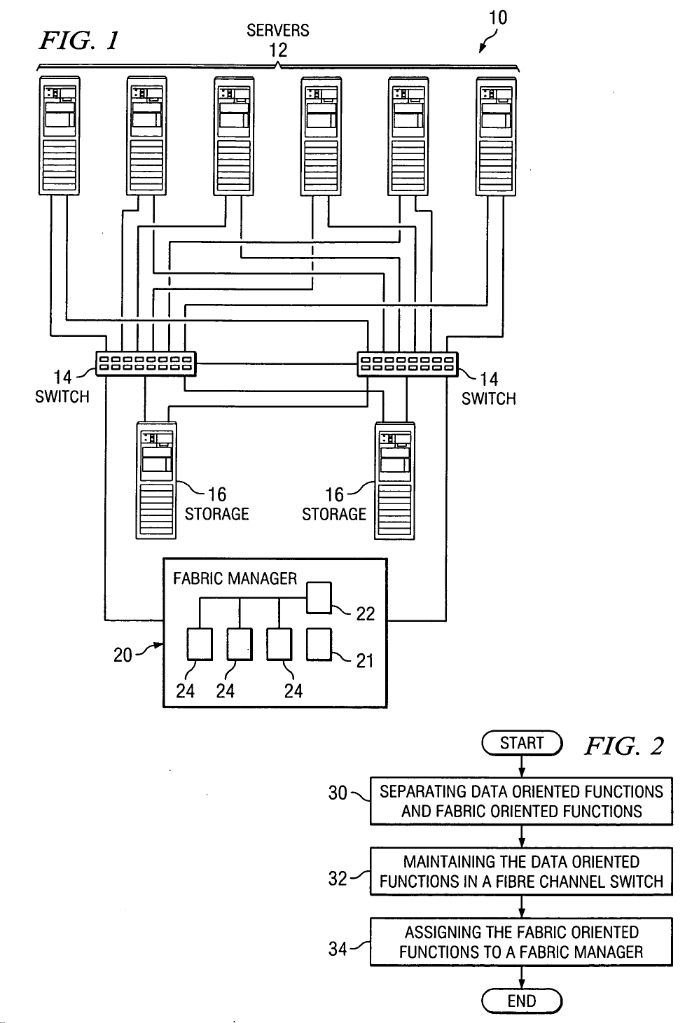

Preferred embodiments and their advantages are best understood by reference to FIGS. 1 and 2, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram showing an example embodiment of storage area network 10 including fabric manager 20 is shown. Storage area network 10 includes storage device units 16 communicatively coupled to fibre channel switch 14. In some embodiments, a plurality of switches may be used to link storage device units 16 to other devices connected to storage area network 10.

Server 12 is one example of another device that may connect to storage area network 10. Generally, one or more servers 12 may communicatively connect to storage device units 16 via switch 14. Server 12 usually connects into one or more switches 14 at switch ports (not expressly shown) for routing data between storage device units 16 and server 12.

Switch 14 typically includes two or more switch ports able to communicatively connect with other devices such as those used to form a fabric. Other components of switch 14 include a path selector, switch construct and a router. These components work together to transfer data from one device to another via a switch port. As such, these components perform functions commonly referred to as data oriented functions such as data path selection, routing, multiplexed frame switching, circuit switching or any combination thereof.

Fabric manager 20 is another device forming a part of SAN 10 that communicatively couples to switch 14. Fabric manager 20 typically connects to each switch 14 at a switch port (not expressly shown). Fabric manager 20 performs functions that are commonly referred to as fabric oriented functions such as management of the one or more switches, health of the fabric, scalability, address manager, failover or any combination thereof. With the fabric oriented functions taken over by fabric manager 20, switch 14 may be able to utilize more of its computing resources on routing data between devices.

In performing the fabric oriented functions, fabric manager 20 may allocate operating modes for switches 14. These operating modes generally include address allocation services. As such, fabric manager 20 will be able to maintain a topological database, typically stored in memory 21. Having the topological database, the fabric may be reconfigured using fabric manager 20, which affects the scalability of the architecture of the fabric.

For example, when a new switch is added to the fabric, the new switch can be configured and initialized with the topological database and address information stored in fabric manager 20. Without fabric manager 20, the newly added switch would generally interact with other switches after these switches have completed any existing tasks. As such, the newly added switch can be added to the fabric without disturbing any of the existing switches.

In some instances, fabric manager 20 may be used to build the fabric. In building the fabric, fabric manager 20 may initiate and perform operations similar to a reconfiguration of the fabric. Having the topological database or information available on demand from fabric manager 20 may free memory in switch 14 that can be applied to caching recently accessed data, studying usage patterns of nodes or other such data oriented functions.

Fabric manager 20 may monitor the health of the fabric. In some embodiments, fabric manager 20 may execute agents in the fabric to periodically monitor the health of the fabric and it components. Generally, this monitoring of the fabric may be referred to as topological synchronization.

In addition to running agent on the fabric, fabric manager 20 may also execute or run decongestion algorithms on itself. These decongestion algorithms may allow fabric manager 20 to reduce unnecessary traffic in network 10.

In case of a failed switch, fabric manager 20 would handle the transition of data flow from the failed switch to a backup switch. Because fabric manager 20 has address information and a topological database, fabric manager 20 may allow for a smooth transition of traffic from the failed switch to the backup switch and possibly even without the nodes realizing the change in switch. For example, fabric manager 20 may backup and store zoning information in addition to the topological information so that new switches have available the same information during fail over and recovery.

Fabric manager 20 are separate and distinct devices from switch 14. In some embodiments, fabric manager 20 includes master fabric manager 22 that usually performs the fabric oriented functions. Master fabric manager 22 may have a plurality of subordinate fabric manager 24 that form a redundant backup for master fabric manager 24. As such, subordinate fabric managers 24 may be a replica of master fabric manager 22 that is waiting in a standby mode as a solution for replacing master fabric manager 22.

FIG. 2 is a flow chart for a method of separating fibre channel switch core functions and management of a fabric in an information handling system such as SAN 10. In one example embodiment, data oriented functions and fabric oriented functions are separated into distinct functions, as shown at block 30. By separating these functions, a device may allocate resources towards performance of their related function without being burdened with performing both functions.

Fibre channel switch 14 will maintain the data oriented functions in the fabric, as shown at block 32. Basic functionality of switch 14 is to route data between devices in SAN 10. Thus, maintaining the data oriented functions in switch 14 may provide fast and efficient transmission of data between device.

Fabric oriented functions are assigned to fabric manager 34 as shown at block 34. Due to the need of monitoring the health of the fabric and switches, fabric manager 20 allows switch 14 to focus on routing/data transfers. In addition, fabric manager may also provide failover management and scalability of the fabric.

Although the disclosed embodiments have been described in detail, it should be understood that various changes, substitutions and alterations can be made to the embodiments without departing from their spirit and scope.

What is claimed is:

1. A method of separating fibre channel switch core functions and management of a fabric in an information handling system, comprising:
separating data oriented functions and fabric oriented functions into distinct components;
maintaining the data oriented functions in one or more switches; and
assigning the fabric oriented functions to a fabric manager, wherein the fabric manager comprises a separate component interconnected with the one or more switches.

2. The method of claim 1, wherein the data oriented functions are selected from a group consisting of data path selection, routing, multiplexed frame switching, circuit switching and any combination thereof.

3. The method of claim 1, wherein the fabric oriented functions are selected from a group consisting of management of the one or more switches, health of the fabric, scalability, address manager, failover and any combination thereof.

4. The method of claim 1, further comprising storing a topological database in the fabric manager.

5. The method of claim 4, further comprising reconfiguring the fabric using information stored in the topological database.

6. The method of claim 1, further comprising executing an agent in the fabric manager to monitor the health of the fabric.

7. The method of claim 1, wherein the fabric manager further comprises:
a master fabric manager acting as a master; and
one or more subordinate fabric managers managed by the master fabric manager, whereby the one or more subordinate fabric managers provide failover if the master fabric manager fails.

8. The method of claim 1, further comprising transitioning traffic from a failed switch to a backup switch in a seamless fashion.

9. A storage area network, comprising:
one or more storage units operable to store data;
a fibre channel switch communicatively coupled to the one or more storage units, the fibre channel switch operable to perform data oriented functions; and
a fabric manager, independent of the fibre channel switch and communicatively coupled to the fibre channel switch, operable to perform fabric oriented functions.

10. The storage area network of claim 9, further comprising:
a server communicatively coupled to the one or more storage units via the fibre channel switch; and
the server operable to access data from one of the storage units via the fibre channel switch.

11. The storage area network of claim 9, further comprising a topological database operably stored in the fabric manager.

12. The storage area network of claim 9, wherein the fabric manager further comprises:
a master fabric manager acting as a master fabric manager for the switch; and
one or more subordinate fabric managers communicatively coupled to and managed by the master fabric manager, the subordinate fabric managers operable to provide failover for the master fabric manager.

13. The storage area network of claim 12, wherein the one or more subordinate fabric managers include a copy of the information stored in the master fabric manager.

14. The storage area network of claim 9, further comprising a monitoring agent operably executed by the fabric manager, the monitoring agent operable to monitor the health of the fabric.

15. An apparatus for separating fibre channel switch core functions and management of a fabric in a storage area network, comprising:
a fabric manager communicatively coupled to a fibre channel switch, wherein the fabric manager is independent from the fibre channel switch; and
the fabric manager operable to perform fabric oriented functions.

16. The apparatus of claim 15, wherein the fabric oriented functions are selected from a group consisting of management of the one or more switches, health of the fabric, scalability, address manager, failover and any combination thereof.

17. The apparatus of claim 15, wherein the fabric manager further comprises:
a master fabric manager acting as a master fabric manager for the switch; and
one or more subordinate fabric managers communicatively coupled to and managed by the master fabric manager, the subordinate fabric managers operable to provide failover for the master fabric manager.

18. The apparatus of claim 17, wherein the one or more subordinate fabric managers comprises a replica of the master fabric manager.

19. The apparatus of claim 15, further comprising a monitoring agent operably executable using the fabric manager, the monitoring agent operable to monitor the health of the fabric.

20. The apparatus of claim 15, further comprising a topological database operably stored in the fabric manager.
